(19) United States
(12) Patent Application Publication
(10) Pub. No.: US 2025/0247476 A1
(43) Pub. Date: Jul. 31, 2025

(54) IMAGE PROCESSING APPARATUS PRESENTING ERROR SOLUTION, CONTROL METHOD THEREFOR, AND STORAGE MEDIUM STORING CONTROL PROGRAM THEREFOR

(71) Applicant: CANON KABUSHIKI KAISHA, Tokyo (JP)

(72) Inventors: YOSUI NAITO, Chiba (JP); KAORI NAKAGAWA, Chiba (JP)

(21) Appl. No.: 18/983,188

(22) Filed: Dec. 16, 2024

(30) Foreign Application Priority Data
Jan. 25, 2024 (JP) 2024-009296

(51) Int. Cl. H04N 1/00; G06F 3/12

(52) U.S. Cl. CPC H04N 1/00029; G06F 3/121; H04N 1/00413

(57) ABSTRACT

An image processing apparatus capable of narrowing down a solution that can resolve an occurring error symptom from among possible solutions and presenting the solution to a user. The image processing apparatus performs various functions related to an image process according to a user operation. A first display unit displays menus indicating error symptoms of the various functions that may occur in the image processing apparatus so as to be selectable by a user. A diagnosis unit perform, when the user selects one of the menus, a diagnosis of the image processing apparatus according to an error symptom indicated in the menu selected by the user. And a second display displays a solution based on a diagnosis result by the diagnosis unit.

### BACKGROUND OF THE INVENTION

### Field of the Invention

The present invention relates to an image processing apparatus, a control method therefor, and a storage medium storing a control program therefor, and in particular to an image processing apparatus, a control method, and a storage medium storing a control program that present a solution to an occurring error symptom.

### Description of the Related Art

Conventionally, an image processing apparatus (hereinafter, simply referred to as an MFP) capable of executing a plurality of functions (printing, image transmission, fax, etc.) related to an image process may cause error termination during execution of these functions and my cause an error symptom in which an output product is not expected even when the termination is normal.

In such a case, a user may attempt to address the problem by checking a product manual. However, if the user cannot solve the problem by oneself, the user may solve an error symptom by querying a call center or, if not, by requesting a service person to be dispatched.

In order to reduce such inquiries to the call center and dispatch of a service person, it is required to provide a function of enabling the user to reach a solution of an error symptom by oneself.

As a conventional technique, a method of presenting an error symptom that has occurred in an MFP and an adjustment item that may solve the error symptom in association with each other on a UI has been proposed (see Japanese Patent Laid-Open Publication No. 2021-39425).

However, when there are a plurality of adjustment items presented on the UI, the method proposed in the above publication requires a user to solve the problem by a trial-and-error method by trying to change set (adjustment) values of the plurality of adjustment items one by one. Further, if the error symptom occurring in the MFP cannot be solved by changing the set (adjustment) value, a user cannot reach a solution.

### SUMMARY OF THE INVENTION

The present invention provides a mechanism by which a solution that can resolve an occurring error symptom can be narrowed down from among possible solutions and presented to a user.

Accordingly, an aspect of the present invention provides an image processing apparatus performing various functions related to an image process according to a user operation, the image processing apparatus including a first display unit configured to display menus indicating error symptoms of the various functions that may occur in the image processing apparatus so as to be selectable by a user, a diagnosis unit configured to perform, when the user selects one of the menus, a diagnosis of the image processing apparatus according to an error symptom indicated in the menu selected by the user, and a second display unit configured to display a solution based on a diagnosis result by the diagnosis unit.

In accordance with the present invention, a solution that can resolve an occurring error symptom can be narrowed down from among possible solutions and presented to a user.

Further features of the present invention will become apparent from the following description of exemplary embodiments with reference to the attached drawings.

### BRIEF DESCRIPTION OF THE DRAWINGS

FIG. 1 is a block diagram showing an example of a hardware configuration of an MFP as an image processing apparatus of the present invention.

FIG. 2 is a view showing an example of a top screen displayed on a display device in FIG. 1 for a user to instruct diagnosis corresponding to an error symptom.

FIG. 3 is a view showing a circuit type currently selected in the MFP.

FIG. 4 is a view showing an example of a guidance display screen displayed on the display device at a time of a board failure.

FIG. 5 is a view showing an example of a guidance display screen displayed on the display device at a time of line cable disconnection.

FIG. 6 is a view showing an example of a guidance display screen displayed on the display device at a time of circuit type mismatch.

FIG. 7 is a view showing an example of a FAX no-abnormality display screen displayed on the display device.

FIG. 8 is a flowchart showing a diagnosis process executed when a user presses a menu indicating the error symptom of “FAX Sending is impossible at all” on the top screen.

FIG. 9 is a flowchart showing a board failure diagnosis process in a step S800 in FIG. 8.

FIG. 10 is flowchart showing a line cable connection diagnosis process in a step S803 in FIG. 8.

FIG. 11 is flowchart showing a circuit type diagnosis process in a step S806 in FIG. 8.

FIG. 12 is a flowchart showing a diagnosis process executed when a user presses a menu indicating an error symptom of “FAX Reception is impossible at all” on the top screen.

FIG. 13 is a view showing an example of a network configuration stored in an HDD in FIG. 1.

FIG. 14 is a view showing an example of a network connection no-abnormality display screen displayed on the display device.

FIG. 15 is a view showing an example of a guidance display screen displayed on the display device at a time of network connection abnormality.

FIG. 16 is a flowchart showing a network connection diagnosis process that is a diagnosis process executed when a user presses a menu indicating an error symptom of “SEND Sending is impossible” on the top screen.

FIG. 17 is a view showing correlations between diagnosis IDs defining contents of diagnoses to be performed by pressing the menus shown in FIG. 2 and functions and error symptoms thereof indicated in the respective menus.

FIG. 18 is a view showing a job history DB stored in the HDD.

FIG. 19 is a view showing an example of a job history display screen displayed on the display device.

FIG. 20 is a view showing an example of a guidance display screen displayed on the display device at a time of a FAX communication error.

FIG. 21 is a flowchart showing an end code diagnosis process that is a diagnosis process executed when a user presses a menu indicating an error symptom of “FAX Sending ends in error” on the top screen.

FIG. 22 is a view showing an end code list stored in the HDD in FIG. 1.

### DESCRIPTION OF THE EMBODIMENTS

Hereafter, embodiments according to the present invention will be described in detail by referring to the drawings.

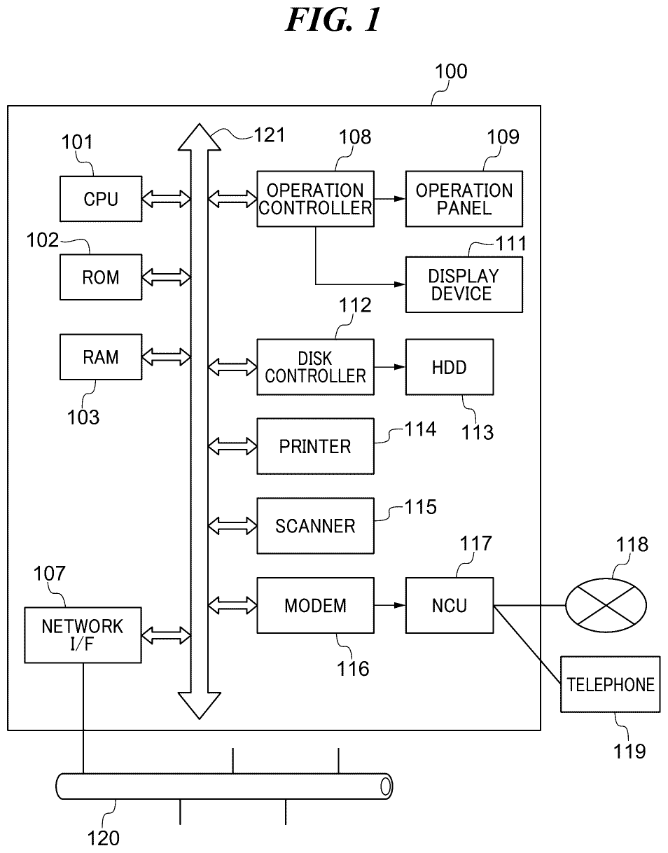

FIG. 1 is a block diagram showing an example of a hardware configuration of an MFP 100 as an image processing apparatus of the present invention.

As shown in FIG. 1, the MFP 100 includes devices, such as a CPU 101, a ROM 102, a RAM 103, a network I/F 107, an operation controller 108, a disk controller 112, a printer 114, a scanner 115, and a modem 116. These devices are mutually connected via a system bus 121.

The CPU 101 executes software stored in the ROM102 or, an HDD (Hard Disk Drive) 113, which will be described later, connected to the disk controller 112. The CPU 101 totally controls the plurality of devices connected to the system bus 121. The HDD 113 may be used as a temporary storage area of an image in some cases.

The RAM 103 functions as a main memory, a work area, etc. of the CPU 101. The operation controller 108 controls various buttons, an operation panel 109, a display device 111, etc. provided in the MFP 100. The disk controller 112 controls the HDD 113.

The network I/F 107 bidirectionally exchanges data with another network device, a file server (neither shown in FIG. 1), or the like via a network 120.

The printer 114 is a printing unit for printing on paper by an electrophotographic method. The printing method may not be particularly limited to the electrophotographic method.

The scanner 115 is an image reading unit for reading an image printed on paper. An ADF (Automatic Document Feeder, not shown) may be attached to the scanner 115 as an option to enable automatic reading of a plurality of documents.

The modem 116 is a device that demodulates modulated signals received from an external FAX (not shown) via a telephone network 118, and conversely modulates signals generated in the MFP 100 and sends them via the telephone network 118. An NCU 117 is an interface to control circuits between the modem 116, the telephone network 118, and a telephone 119. Specifically, the NCU 117 detects a signal coming from the telephone network 118 and transmits the signal to the modem 116 or the telephone 119, or transmits a signal from the modem 116 to an external FAX (not shown) via the telephone network 118. The NCU 117 also transfers a signal from the telephone 119 to the telephone network 118 to transmit the signal to an external phone (not shown). The public network (telephone network 118) may not be directly connected to the NCU 117, but may be connected to the NCU 117 via a TA (Terminal Adapter), an extension exchange, or the like.

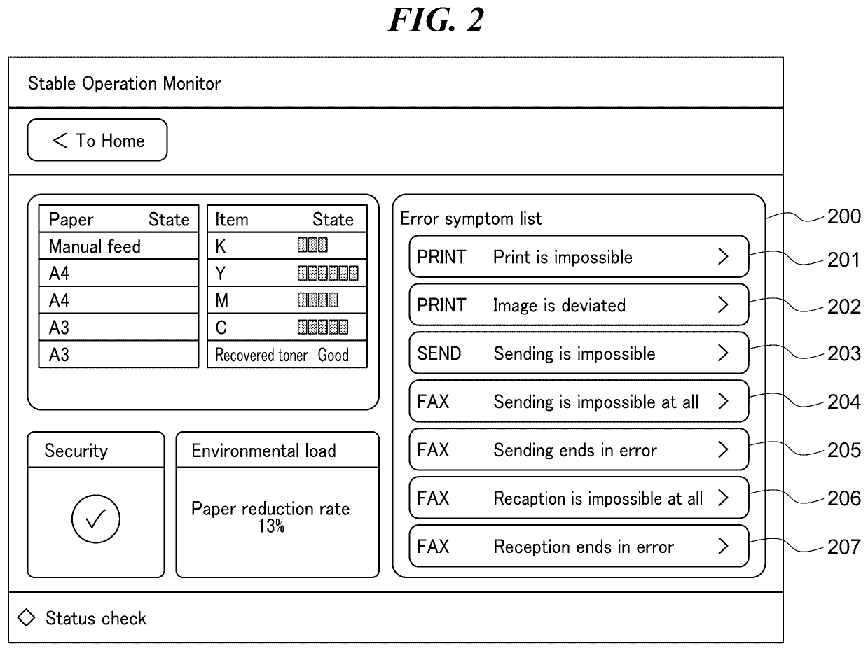

FIG. 2 is a view showing an example of a top screen displayed on the display device 111 by the CPU 101 (a first display unit) for a user to instruct diagnosis corresponding to an error symptom.

As shown in FIG. 2, the top screen includes an error symptom list 200 including menus 201 to 207 that indicate error symptoms, which may occur in the MFP 100, of various functions related to an image process executed in response to a user operation. The user can select one of the menus 201 to 207 by pressing a menu to be selected.

The menus 201 to 207 are merely examples, and these are not limiting. For example, FIG. 2 shows PRINT, SEND, and FAX as the functions relating to the image process in the MFP 100, but other functions such as COPY may be included. In this embodiment, the top screen in FIG. 2 is displayed on the display device 111 by the CPU 101 when the user uses any of the various functions and an error symptom appears in the function being used, but the display timing of the top screen in FIG. 2 is not limited thereto. For example, the CPU 101 may display the top screen in FIG. 2 on the display device 111 immediately after the MFP 100 is activated. Thus, when the user starts the MFP 100, it is possible to check whether the various functions of the MFP 100 can be used without any problem.

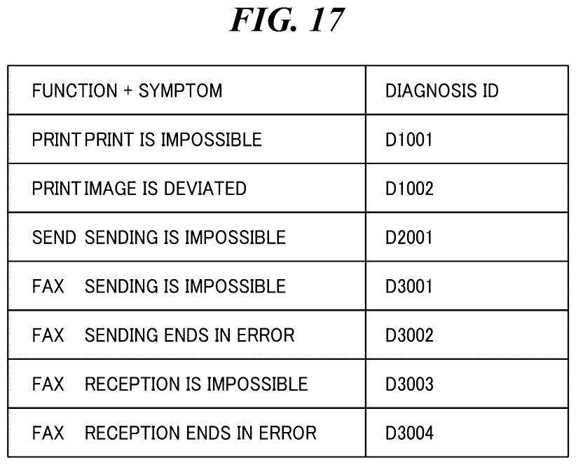

FIG. 17 is a view showing correlations between diagnosis IDs defining contents of diagnoses to be performed by pressing the menus 201 to 207 shown in FIG. 2 and the functions and error symptoms thereof indicated in the respective menus 201 to 207. In this way, the contents to be diagnosed are determined in advance for the respective menus, and the optimum diagnosis can be performed for each error symptom.

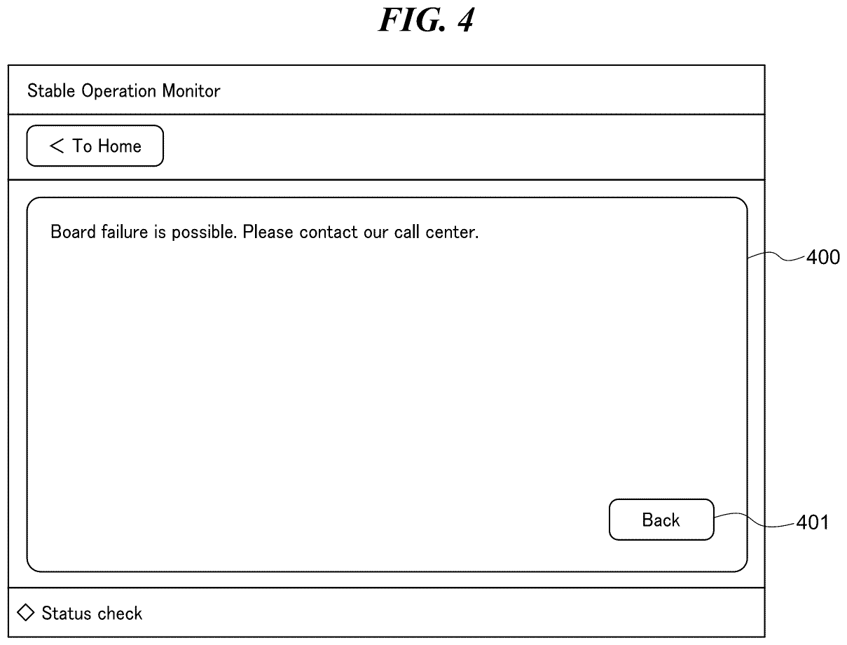

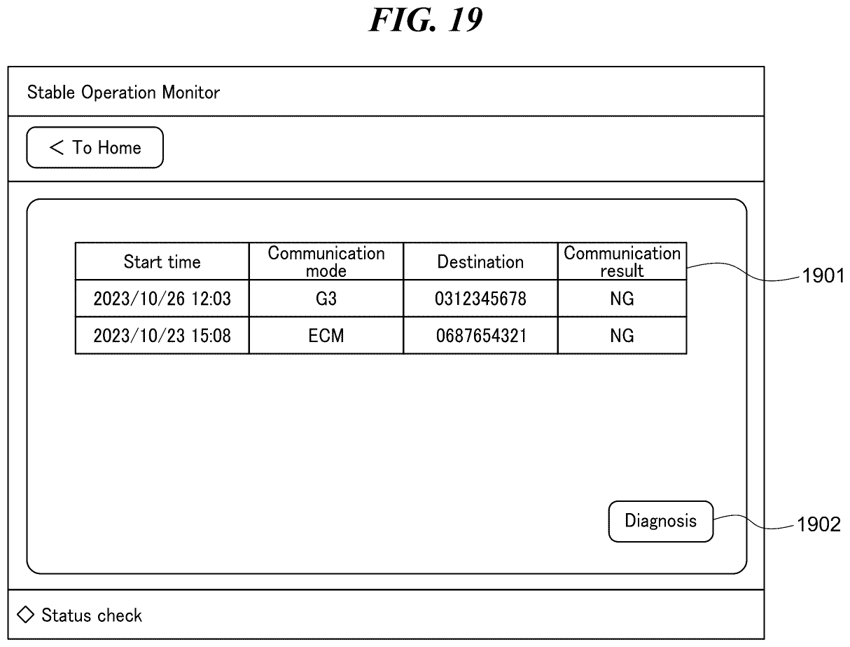

FIGS. 4 to 7, 19, and 20 show examples of screens displaying results of FAX diagnoses. A diagnosis result display area 400 and a back button 401 for returning a screen display are displayed in common on each of the screens in FIGS. 4 to 7, and 20. In FIG. 19, a job history 1901 and a diagnosis button 1902 for selecting one from the job history and instructing diagnosis are displayed. The screens shown in FIGS. 4 to 7, 19, and 20 will be described in detail below.

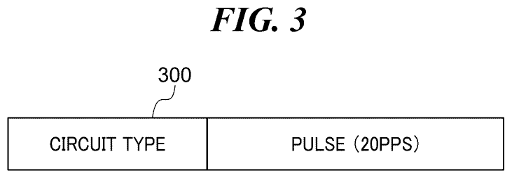

Next, a FAX diagnosis process will be described. First, a diagnosis process executed when a user presses the menu 204 indicating the error symptom of “FAX Sending is impossible at all” (the diagnosis ID shown in FIG. 17 is D3001) on the top screen (FIG. 2) will be described with reference to FIGS. 3 to 11.

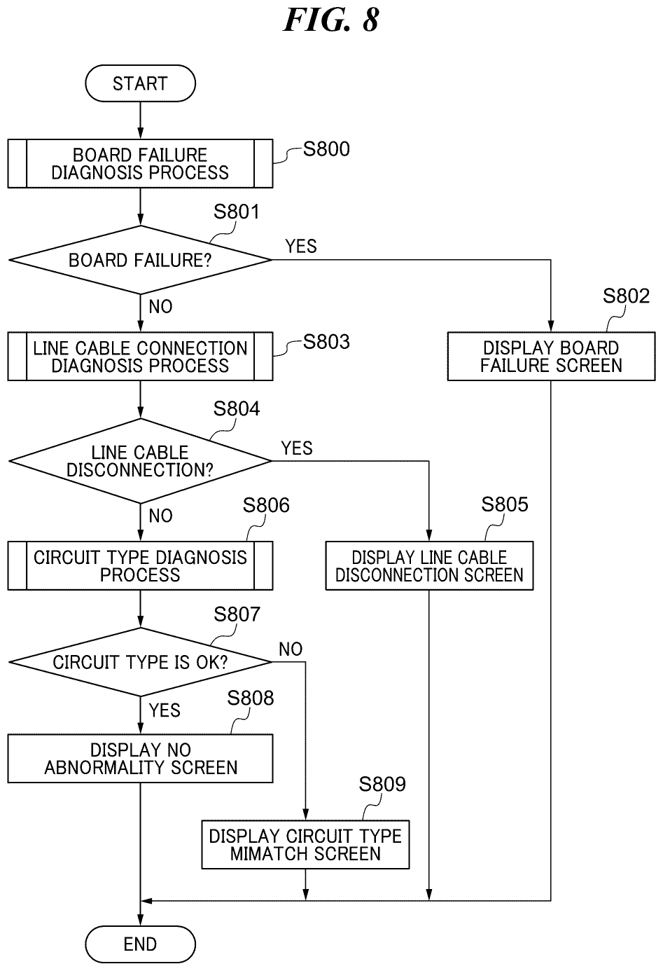

FIG. 8 is a flowchart showing the diagnosis process executed when the user presses the menu 204 indicating the error symptom of “FAX Sending is impossible at all” on the top screen. Series of processes are performed by the CPU 101 (a diagnosis unit) reading a program that describes a procedure described below and is executable by the MFP 100 from the ROM 102 onto the RAM 103 and executing the program.

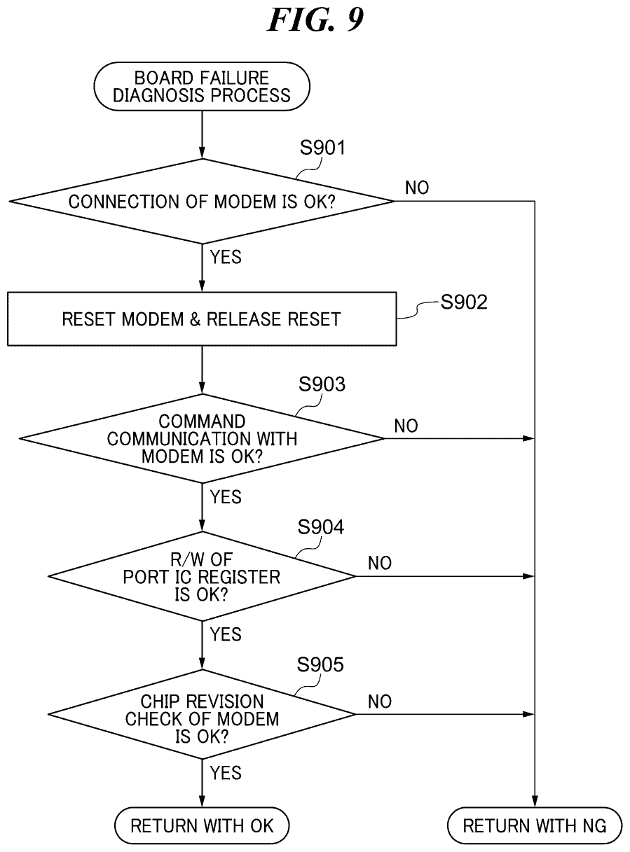

First, a board failure diagnosis process for diagnosing the presence or absence of a failure of a fax board (hereinafter, simply referred to as a board failure), which will be described later using a flowchart in FIG. 9, is performed in a step S800. A diagnosis result (a return value) obtained by this process is determined in a step S801.

In the determination in the step S801, when the return value of the process in the step S800 is NG, it is determined that there is the board failure (YES in the step S801), and the process proceeds to a step S802. In the step S802, the CPU 101 (a second display unit) displays a message to notify a user of the board failure in a guidance display screen displayed on the display device 111 at a time of the board failure as shown in FIG. 4.

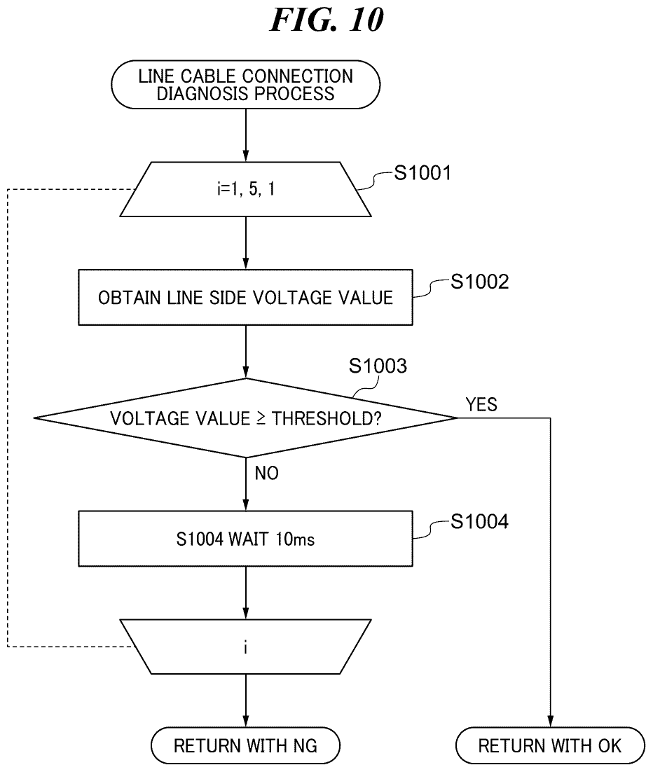

On the other hand, in the determination in the step S801, when the return value of the process in the step S800 is OK, it is determined that there is no board failure (NO in the step S801), and then a line cable connection diagnosis process in a step S803 is performed. The details of this process will be described later using a flowchart in FIG. 10. The diagnostic result obtained by this process is determined in a step S804.

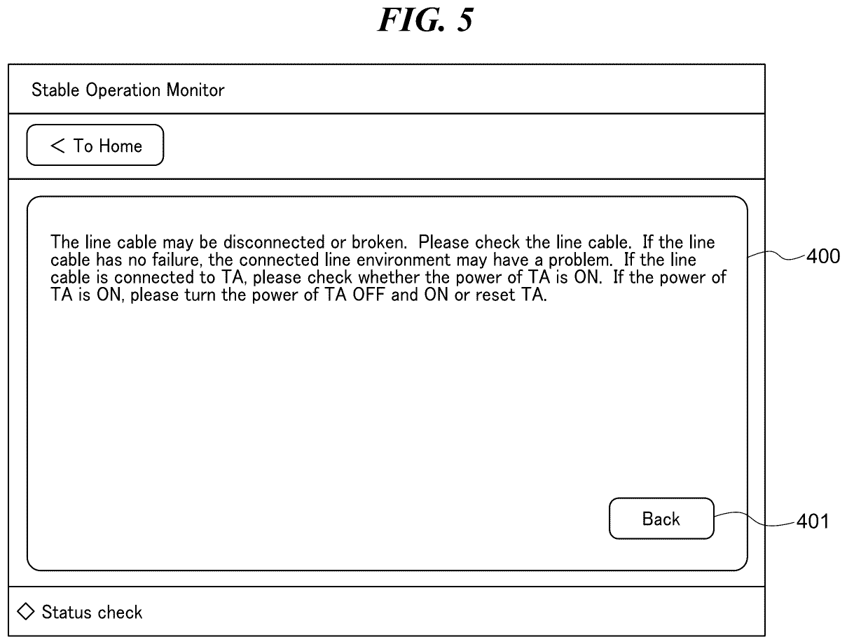

In the determination in the step S804, when the return value of the process in the step S803 is NG, it is determined that the line cable is disconnected (YES in the step S804), and the process proceeds to a step S805. Then, the CPU 101 displays a message to notify a user of the line disconnection in a guidance display screen displayed on the display device 111 at a time of the line cable disconnection as shown in FIG. 5.

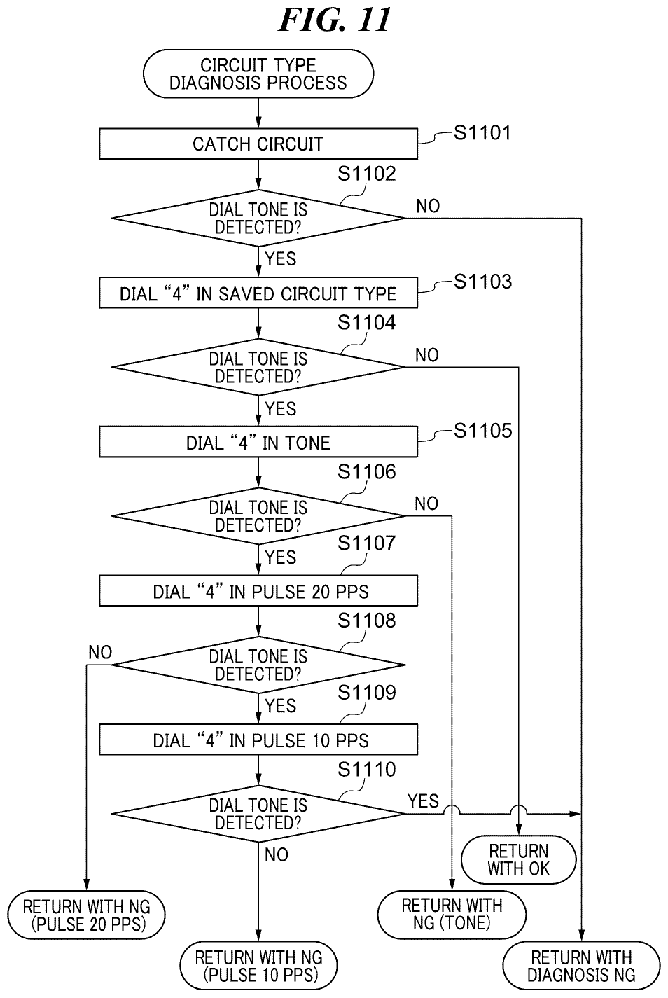

On the other hand, in the determination in the step S804, when the return value of the process in the step S803 is OK, it is determined that the line is not disconnected (NO in the step S804), and then a circuit type diagnosis process in a step S806 is performed. The details of this process will be described later using a flowchart in FIG. 11. The diagnosis result obtained by this process is determined in a step S807.

In the determination in the step S807, when the return value of the process in the step S806 is other than OK, it is determined that the line types do not match (NO in the step S807), and the process proceeds to a step S809.

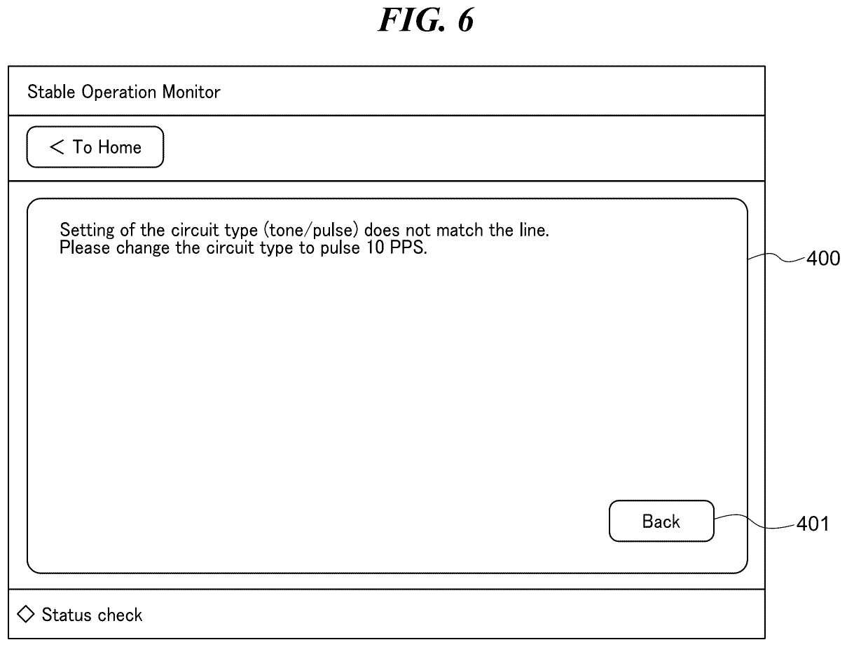

In the step S809, the CPU 101 displays a message (guidance) to prompt a user to change the circuit type in a guidance display screen (FIG. 6) displayed on the display device 111 in a case of circuit type mismatch. Here, FIG. 6 shows the case where the return value of the process in the step S806 is “NG (pulse 10 PPS)” and the message to prompt a user to change the circuit type to pulse 10 PPS is displayed in the guidance display screen for the circuit type mismatch in the step S809. When the return value of the process in the step S806 is “NG (pulse 20 PPS)”, a message to prompt a user to change the circuit type to pulse 20 PPS (not shown) is displayed on the display device 111 in the guidance display screen for the circuit type mismatch in the step S809. When the return value of the process in the step S806 is “NG (tone)”, a message to prompt a user to change the circuit type to tone (not shown) is displayed on the display 111 in the guidance display screen for the circuit type mismatch in the step S809. When the return value of the process in the step S806 is “diagnosis NG”, an error message indicating that the circuit type cannot be diagnosed normally (not shown) is displayed on the display device 111 in the guidance display screen for the circuit type mismatch in the step S809.

On the other hand, in the determination in the step S807, when the return value of the process in the step S806 is “OK”, it is determined that there is no fax abnormality (YES in the step S807), and the process proceeds to a step S808.

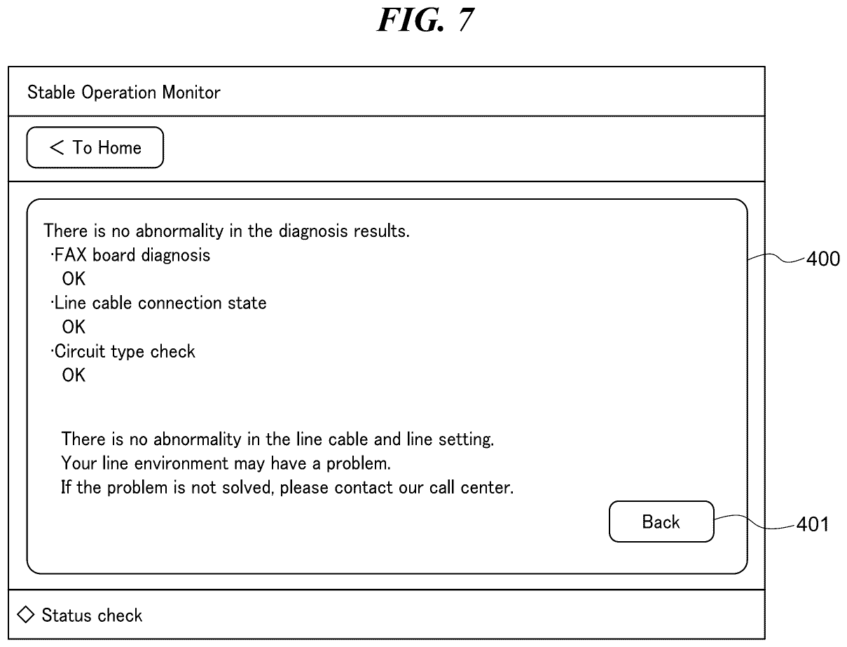

In the step S808, the CPU 101 displays a guidance message indicating that no abnormality is detected in the fax function in a fax no-abnormality display screen as shown in FIG. 7 on the display device 111.

Next, the board failure diagnosis process in the step S800 will be described using the flowchart in FIG. 9.

First, in a step S901, the CPU 101 reads a hardware port indicating whether the modem 116 is connected and performs a connection check. When the connection of the modem 116 cannot be detected due to a board failure or a poor connection of a connector for connecting the fax board (NO in the step S901), the CPU 101 determines that the connection is NG, sets the return value to NG, and ends the process. In this case, an error code indicating the connection NG may be displayed on the guidance display screen (FIG. 4) at the time of the board failure in the step S802.

On the other hand, when the connection of the modem 116 is detected, the CPU 101 determines that the connection is OK (YES in the step S901), and proceeds with the process to a step S902. In the step S902, the CPU 101 controls a reset port of the modem 116 to reset the modem 116 and release the reset. Thereafter, in a step S903, the CPU 101 transmits a command to the modem 116 and receives a response to the command to check communication with the modem 116 (a communication check). When the response cannot be normally received, the CPU 101 determines that the communication is NG (NO in the step S903), sets the return value to NG, and ends the process. In this case, an error code indicating the communication NG may be displayed on the guidance display screen (FIG. 4) at the time of the board failure in the step S802.

On the other hand, when the response is normally received, the CPU 101 determines that the communication is OK (YES in the step S903) and proceeds with the process to a step S904. In the step S904, the CPU 101 checks reading and writing of a value of a port-IC register of the fax board and determines whether the register R/W is OK or NG. As a result of the determination, when the register R/W is OK (YES in the step S904), the CPU 101 proceeds with the process to a step S905. When the register R/W is NG (NO in the step S904), the CPU 101 sets the return value to NG and ends the process.

Here, the check of the reading and writing of a value of the port-IC register (hereinafter, simply referred to as a register) of the fax board in step S904 is performed the following method. First, the CPU 101 writes “1” to the port-IC register, reads the register value, and determines whether the value of “1” can be obtained. When the value of “1” cannot be obtained, the CPU 101 determines that the register R/W is NG. On the other hand, when the value of “1” is obtained, the CPU 101 writes “0” to the register, reads the register value again, and determines whether the value of “0” can be obtained. When the value of “0” cannot be obtained, the CPU 101 determines that the register R/W is NG. On the other hand, when the value of “0” is obtained, the CPU 101 determines that the register R/W is OK. When the CPU 101 determines in the step S904 that the register R/W is NG, an error code indicating that the register R/W is NG may be displayed on the guidance display screen (FIG. 4) at the time of the board failure in the step S802.

In the step S905, the CPU 101 sends a command to modem 116 to get a chip revision. When receiving the response from the modem 116, the CPU 101 checks the value of the revision (a revision check) and determines whether the value of the revision matches a predetermined value. If the two values match, the CPU 101 determines that the revision check is OK (YES in the step S905), sets the return value to OK, and ends the process. On the other hand, when the two values do not match, the CPU 101 determines that the revision check is NG (NO in the step S905), sets the return value to NG, and ends the process. In this case, an error code indicating that the revision check is NG may be displayed on the guidance display screen (FIG. 4) at the time of the board failure in the step S802.

The user can easily perform the connection check and the failure check of the fax board by the board failure diagnosis process in the step S800.

The line cable connection diagnosis process in the step S803 will now be described with reference to the flowchart in FIG. 10. Normally, when the line cable is correctly connected to the MFP 100 and the telephone network 118, a constant voltage is applied to the NCU 117. Since the CPU 101 can obtain the voltage value applied to the NCU 117 side via the modem 116, the CPU 101 checks the voltage value. When the NCU 117 receives a signal of an incoming call from the telephone network 118, the voltage applied to NCU117 draws a sinusoidal wave centering the voltage applied during standby. Therefore, even if the line cable is correctly connected, when the CPU 101 checks the voltage value only once at a certain moment in receiving the incoming call signal, the voltage value as a result of the check may become 0V. Therefore, in the line cable connection diagnosis process of this embodiment, as shown in the flowchart in FIG. 10, the CPU 101 checks (confirms) the voltage value applied to the NCU 117 side five times at constant intervals, and when the voltage value checked is equal to or more than the threshold at least one time, it is determined that the line cable is correctly connected. The number of times of checking the voltage value may be two or more, and is not limited to five as exemplified in this embodiment.

In FIG. 10, first, in a step S1001, the CPU 101 executes a loop process up to five times. As a process executed in the loop, in a step S1002, the CPU 101 transmits a command to obtain a line side voltage value of the NCU 117 to the modem 116 and obtains the voltage value. Next, in a step S1003, the CPU 101 determines whether the voltage value obtained in the step S1002 is equal to or more than a threshold. As a result of the determination, when the obtained voltage value is less than the threshold (NO in the step S1003), the CPU 101 proceeds with the process to a step S1004. After waiting for 10 ms in the step S1004, the CPU 101 returns the process to the beginning of the loop process. On the other hand, as the result of the determination, when the obtained voltage value is equal to or more than the threshold (YES in the step S1003), the CPU 101 exits the loop process, sets the return value to OK, and ends the process.

When the CPU 101 does not determine that the obtained voltage value is equal to or more than the threshold in the step S1003 even if the loop process from the step S1001 is executed up to five times, the CPU 101 finally sets the return value to NG and ends the process.

By the above-mentioned line cable connection diagnosis process in the step S803, it is possible to diagnose the connection of the telephone line, that is, to diagnose whether the line cable is correctly connected to the MFP 100 and the telephone network 118.

Next, the circuit type diagnosis process in the step S806 in FIG. 8 will be described with reference to FIGS. 3 and 11.

The circuit type 300 shown in FIG. 3 is the circuit type currently selected by the user as the circuit type to be used when sending a fax from the MFP 100. The circuit type 300 is data stored in the HDD 113 and is selected one from tone, pulse 20 PPS, and pulse 10 PPS. Unless sending a fax to the telephone network 118 by using the circuit type applicable to the network, the dial number selected by a user as a fax sending destination is not normally recognized by the network side. Therefore, if the circuit type 300 is set incorrectly, the MFP 100 cannot send a fax normally. When the modem 116 catches the circuit of the telephone network 118, the telephone network 118 transmits a tone signal, which is called a dial tone signal, having a predetermined tone and cadence to the MFP 100 side. The dial tone signal is transmitted for a predetermined time period until a dial operation (setting of a destination phone number) is performed in the method of the correct circuit type in the MFP 100. However, if the circuit type of the method is incorrect, the telephone network 118 does not stop sending the dial tone signal even if the dial operation is performed. In this embodiment, therefore, it is determined whether the circuit type used for dialing is correct by checking whether the dial tone signal is stopped in the circuit type diagnosis process in the step S806 in FIG. 8.

Hereinafter, the details of the circuit type diagnosis process in the step S806 in FIG. 8 will be described using a flowchart in FIG. 11.

First, in a step S1101, the CPU 101 sends a command to the modem 116 to catch the circuit of the telephone network 118. When the modem 116 detects this command and catches the circuit of the telephone network 118 via the NCU 117, the telephone network 118 sends the dial tone signal to the MFP 100 side.

Next, the process proceeds to a step S1102, and the CPU 101 determines whether the modem 116 detects the dial tone signal transmitted from the telephone network 118 and returns a response indicating the detection (detection response) to the telephone network 118. When the detection response is not returned, the CPU 101 determines that the dial tone is not detected (NO in the step S1102) and returns NG because the circuit type diagnosis cannot be correctly performed. Here, when the NCU 117 is not directly connected to the public network (telephone network 118) but is connected to a TA, an extension exchange, or the like, and an unexpected dial tone is generated, the detection response is not returned, for example. On the other hand, when the detection response is returned, the CPU 101 determines that the dial tone is detected (YES in the step S1102) and proceeds with the process to a step S1103.

In the step S1103, the CPU 101 first obtains the pulse 20 PPS that is the value of the currently selected line type 300 from the HDD 113. If the value of the currently selected line type 300 is the pulse 10 PPS, the CPU 101 obtains the pulse 10PPS in the step S1103. If the value of the currently selected line type 300 is the tone, the CPU 101 obtains the tone in the step S1103. When obtaining the pulse 20 PPS, the CPU 101 designates the method of the circuit type to the pulse 20 PPS, transmits a command for dialing using a one-digit phone number (“4” in this embodiment) to the modem 116, and proceeds with the process to a step S1104. When detecting the command, the modem 116 dials “4” in the pulse 20 PPS.

In the step S1104, the CPU 101 determines whether the dial tone is detected. The determination method here is the same as the method in the step S1102, and thus the description thereof will be omitted. When determining that the dial tone is not detected (i.e., the dial tone is stopped) after the dialing in the step S1103 (NO in the step S1104), the CPU 101 sets the return value to OK and ends this process. That is, the CPU 101 determines that the value of the circuit type 300 that has been set is suitable for the telephone network 118 connected. On the other hand, when the CPU 101 determines that the dial tone is still detected after the dialing in the step S1103 (YES in the step S1104), the process proceeds to a step S1105.

In the step S1105, the CPU 101 changes the circuit type to the tone and sends a command to the modem 116 to dial using the one-digit phone number (“4” in this embodiment) and proceeds with the process to a step S1106. When detecting this command, the modem 116 dials “4” in the tone.

Next, the CPU 101 again determines whether the dial tone is detected in the step S1106. The determination method here is the same as the method in the step S1102, and thus the description thereof will be omitted. When determining that the dial tone is not detected after the circuit type is changed to the tone in the step S1105 (NO in the step S1106), the CPU 101 sets the return value to NG (tone) and ends this process. On the other hand, when determining that the dial tone is still detected after the circuit type is changed to the tone in the step S1105 (YES in the step S1106), the CPU 101 proceeds with the process to a step S1107.

In the step S1107, the CPU 101 changes the circuit type to the pulse 20 PPS and sends a command to the modem 116 to dial using the one-digit phone number (“4” in this embodiment) and proceeds with the process to a step S1108. When detecting the command, the modem 116 dials “4” in the pulse 20 PPS.

The CPU 101 again determines whether the dial tone is detected in the step S1108. The determination method here is the same as the method in the step S1102, and thus the description thereof will be omitted. When determining that the dial tone is not detected after changing the circuit type to the pulse 20 PPS in the step S1107 (NO in the step S1108), the CPU 101 sets the return value to NG (pulse 20 PPS) and ends this process. On the other hand, when determining that the dial tone is still detected after the circuit type is changed to the pulse 20 PPS in the step S1107 (YES in the step S1108), the CPU 101 proceeds with the process to a step S1109.

In the step S1109, the CPU 101 changes the circuit type to the pulse 10 PPS and sends a command to the modem 116 to dial using the one-digit phone number (“4” in this embodiment) and proceeds with the process to a step S1110. When detecting the command, the modem 116 dials “4” in the pulse 10 PPS.

The CPU 101 again determines whether the dial tone is detected in the step S1110. The determination method here is the same as the method in the step S1102, and thus the description thereof will be omitted. When determining that the dial tone is not detected after changing the circuit type to the pulse 10 PPS in the step S1109 (NO in the step S1110), the CPU 101 sets the return value to NG (pulse 10 PPS) and ends this process. On the other hand, when determining that the dial tone is still detected after the circuit type is changed in the step S1109 (YES in the step S1110), the CPU 101 sets the return value to the diagnosis NG because the circuit type diagnosis cannot be correctly performed and ends this process.

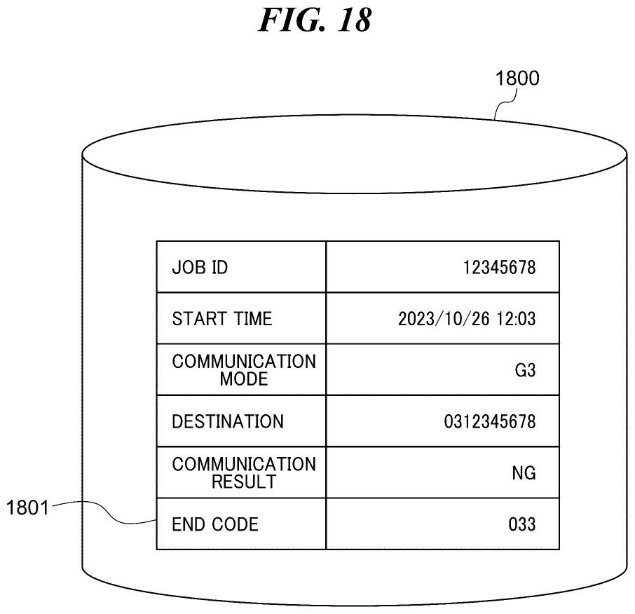

Next, an end code diagnosis process that is a diagnosis process executed when the user presses the menu 205 indicating the error symptom of “FAX Sending ends in error” (the diagnosis ID is D3002) on the top screen (FIG. 2) will be described with reference to FIGS. 18 to 21.

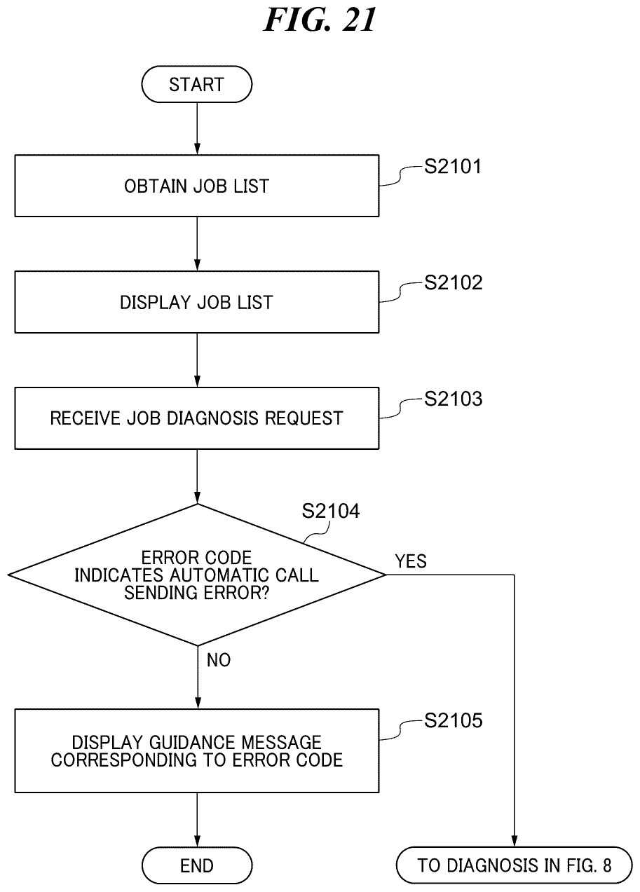

FIG. 21 is a flowchart showing the end code diagnosis process. Series of processes are performed by the CPU 101 reading a program that describes a procedure described below and is executable by the MFP 100 from the ROM 102 onto the RAM 103 and executing the program.

First, in a step S2101, the CPU 101 obtains a list of jobs that have ended in error due to a fax error from a job history DB 1800 (FIG. 18) stored in the HDD 113. Next, in a step S2102, the CPU 101 displays a job history display screen (FIG. 19) including the list obtained in the step S2101 on the display device 111.

Next, when the diagnosis button 1902 is pressed in a state where one job record is selected in the job history 1901 on the job history display screen (FIG. 19) in a step S2103, the CPU 101 determines that a job diagnostic request is given from a user and proceeds with the process to a step S2104.

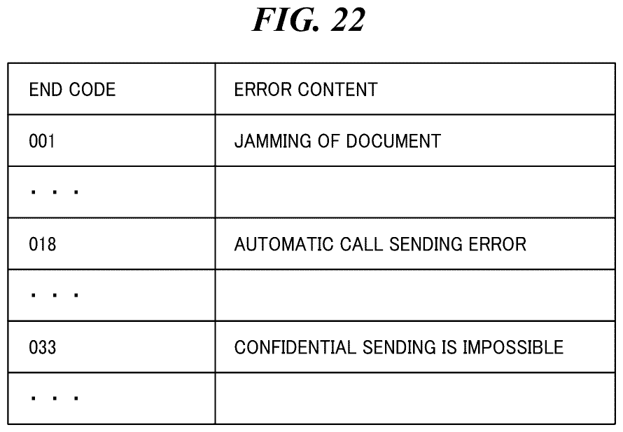

In the step S2104, the CPU 101 performs an end code diagnosis to determine the value of the end code of the job record selected in the step S2103 according to an end code list (FIG. 22) stored in the HDD 113. As a result of the determination, when the value of the end code is not “018” indicating “automatic call sending error” (NO in the step S2104), the CPU 101 proceeds with the process to a step S2105. On the other hand, when the value of the end code is “018” (YES in the step S2104), the diagnostic process shown in FIG. 8 is executed.

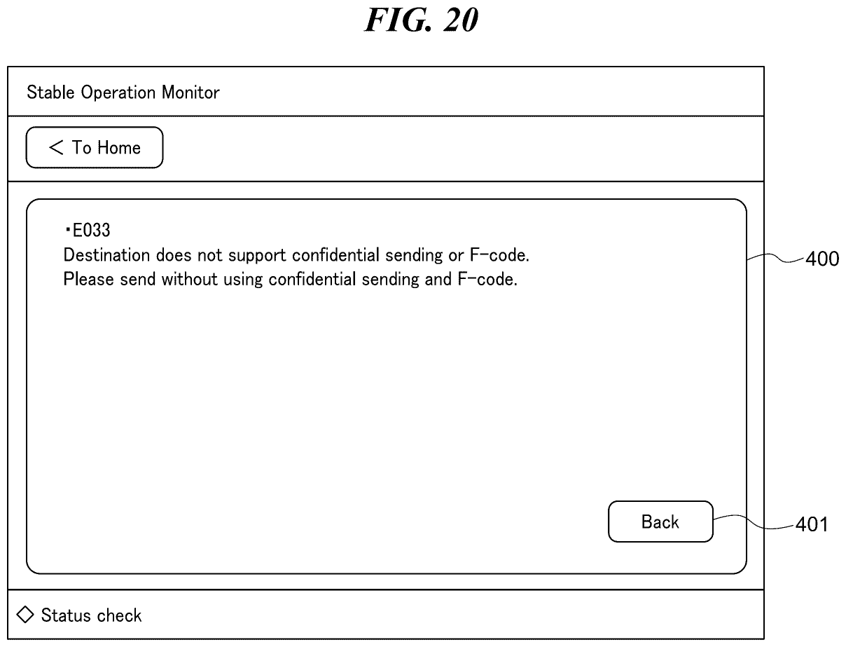

In the step S2105, the CPU 101 displays a guidance display screen for a fax communication error as shown in FIG. 20 on the display device 111, notifies the user of a guidance indicating a solution corresponding to the end code, and ends this process. The guidance in the guidance display screen in FIG. 20 exemplifies the guidance in the case where the value of the end code of the job record selected in the step S2103 is 033 (FIG. 18).

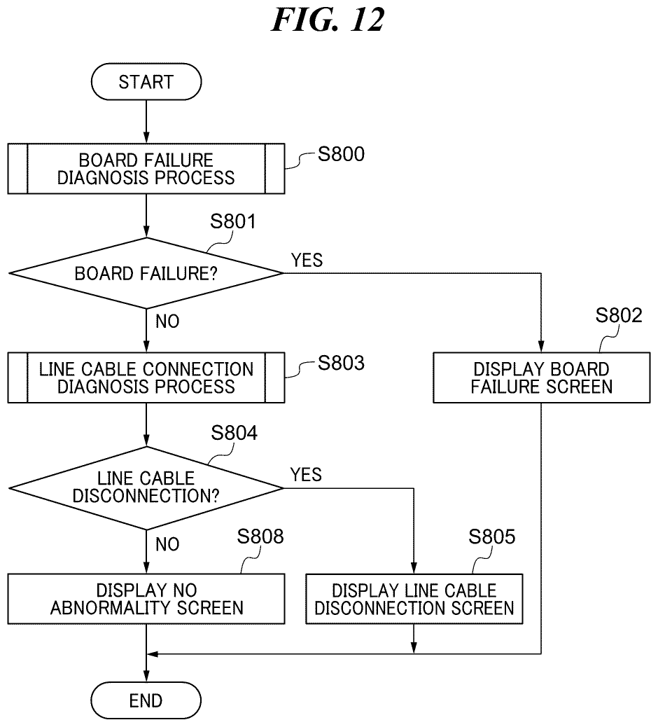

Next, a diagnosis process executed when the user presses the menu 206 indicating the error symptom of “FAX Reception is impossible at all” (the diagnosis ID is D3003) will be described with reference to a flowchart in FIG. 12. In this diagnosis process, the fax reception is not related to the dialing process. Therefore, the circuit type diagnosis process (the step S806) and the related processes (the steps S807 and S809) in the flowchart (FIG. 8) of the diagnosis process for “FAX Sending is impossible” are omitted in the flowchart in FIG. 12. The other steps in FIG. 12 are the same as the corresponding steps in FIG. 8, and the descriptions thereof will be omitted.

As described above, since the FAX diagnosis is performed while changing the diagnosis contents according to the symptom and the result is displayed, it is possible to present the failure solution information with a high possibility to the user. The FAX diagnosis is not limited to the contents described here, and another diagnosis example may be performed.

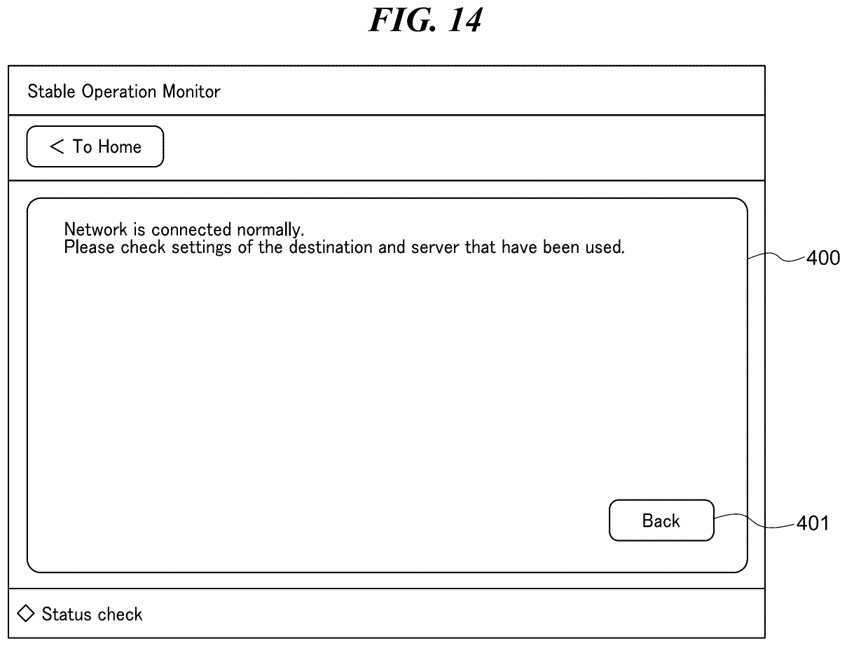

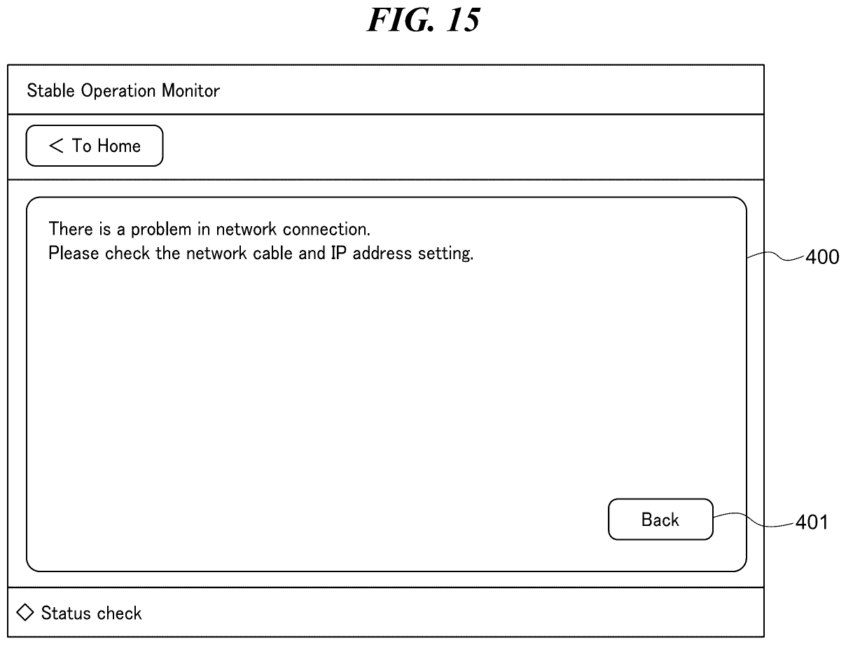

FIGS. 14 and 15 are examples of screens that display results of SEND diagnoses. The SEND is a generic name of image transmission functions, such as Email, SMB, FTP, I-FAX, and WebDav. A diagnostic result display area 4000 and a back button 4001 for returning the screen display are displayed in common on each screen. The details of each screen will be described later.

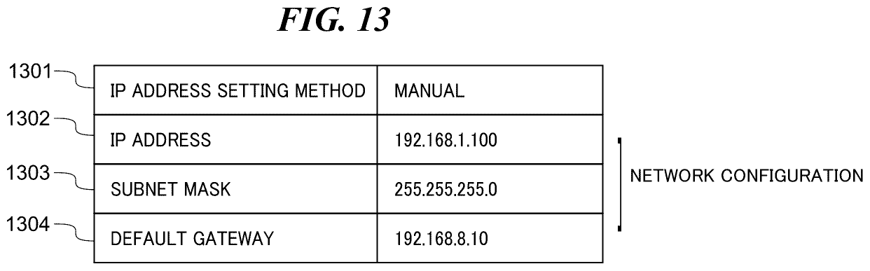

Next, a network connection diagnosis process, which is a diagnosis process executed when the user presses the menu 203 indicating the error symptom of “SEND Sending is impossible” (the diagnosis ID shown in FIG. 17 is D201) on the top screen (FIG. 2) will be described with reference to FIGS. 13 to 16. Here, the SEND function means data transmission by any one of transmission methods of Email, SMB, FTP, I-FAX, and WebDav.

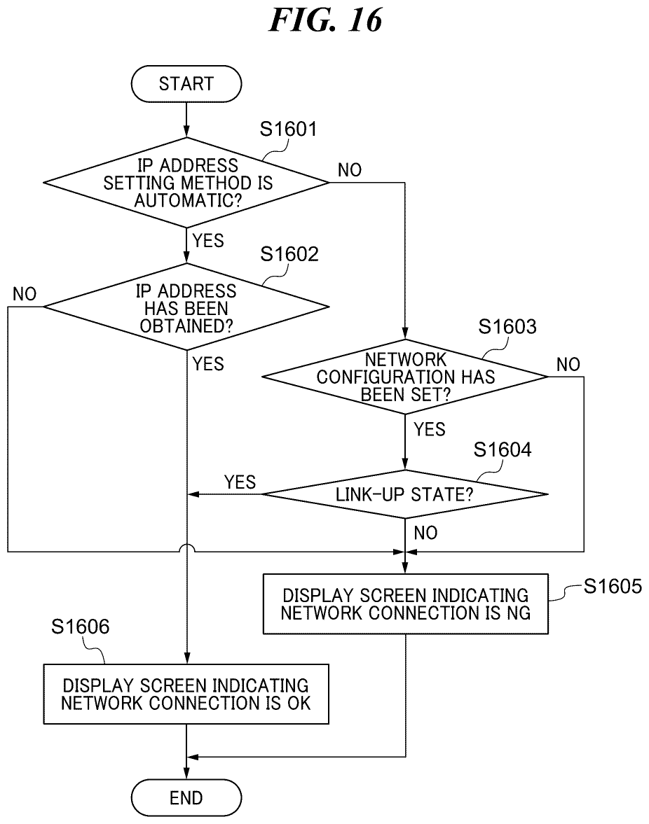

FIG. 16 is a flowchart showing the network connection diagnosis process. Series of processes are performed by the CPU 101 reading a program that describes a procedure described below and is executable by the MFP 100 from the ROM 102 onto the RAM 103 and executing the program.

First, in a step S1601, the CPU 101 reads an IP address setting method 1301 in FIG. 13 stored in the HDD 113 and determines whether the IP address setting method is automatic or manual. When the automatic setting method is set (YES in the step S1601), the process proceeds to a step S1602. When the manual setting method is set (NO in the step S1601), the process proceeds to a step S1603.

In the step S1602, the CPU 101 determines whether the IP address has been obtained via the network I/F 107. When the IP address has been obtained (YES in the step S1602), the CPU 101 proceeds with the process to a step S1606, displays a message indicating that the network connection is normal in a network connection no-abnormality display screen (FIG. 14) on the display device 111, and ends this process. On the other hand, when the IP address has not been obtained (NO in the step S1602), the process proceeds to a step S1605. In the step S1605, the CPU 101 displays a message indicating that there is a problem in the network connection in a guidance display screen (FIG. 15) at a time of the network connection abnormality on the display device 111, and ends this process.

In the step S1603, the CPU 101 reads a network configuration in FIG. 13 stored in the HDD 113 and determines whether the settings of the network configuration has been completed. Here, the network configuration includes configurations of the IP address 1302, a subnet mask 1303, and a default gateway 1304. When it is determined that the setting of the network configuration has been completed (YES in the step S1603), the process proceeds to a step S1604. On the other hand, when it is determined that the setting of the network configuration has not been completed (NO in the step S1603), the process proceeds to the step S1605 described above.

In the step S1604, the CPU 101 determines whether a link-up state is established via the network I/F 107. As a result of the determination, when the link-up state has been established (YES in the step S1604), the process proceeds to the step S1606 described above. When the link-up state is not established, that is, in a link-down state (NO in the step S1604), the process proceeds to the step S1605 described above.

By performing the above-mentioned diagnosis, it becomes possible to notify the user of the diagnosis result regarding the network connection in the case where the SEND function is disable. In this embodiment, although the screens shown in FIGS. 14 and 15 are described as examples of the SEND diagnosis results, these are not limiting and other diagnosis results may be displayed.

Although the CPU 101 in the MFP 100 diagnoses the various error symptoms occurring in the MFP 100 in this embodiment, an external server or an AI communicatively connected to the MFP 100 may diagnose the various error symptoms.

Although the preferred embodiment of the present invention have been described above, the present invention is not limited to the above-described embodiment, and various modifications and changes can be made within the scope of the gist of the present invention.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-009296, filed Jan. 25, 2024, which is hereby incorporated by reference herein in its entirety.

What is claimed is:

1. An image processing apparatus performing various functions related to an image process according to a user operation, the image processing apparatus comprising:
a first display unit configured to display menus indicating error symptoms of the various functions that may occur in the image processing apparatus so as to be selectable by a user;
a diagnosis unit configured to perform, when the user selects one of the menus, a diagnosis of the image processing apparatus according to an error symptom indicated in the menu selected by the user; and
a second display unit configured to display a solution based on a diagnosis result by the diagnosis unit.

2. The image processing apparatus according to claim 1, wherein when the user selects a menu indicating that fax sending is impossible at all from among the menus, the diagnosis unit performs at least one of a board failure diagnosis, a line cable connection diagnosis, and a circuit type diagnosis as the diagnosis.

3. The image processing apparatus according to claim 1, wherein when the user selects a menu indicating that fax sending ends in error from among the menus, the diagnosis unit performs an end code diagnosis as the diagnosis.

4. The image processing apparatus according to claim 3, wherein an end code of a job record of a job that has ended in error due to a fax error in the image processing apparatus is obtained in the end code diagnosis;
wherein the diagnosis unit performs, when the end code obtained indicates an automatic call sending error, at least one of a board failure diagnosis, a line cable connection diagnosis, and a circuit type diagnosis as the diagnosis, and
wherein the second display unit displays, when the end code obtained does not indicate the automatic call sending error, a solution corresponding to the end code obtained without performing a diagnosis by the diagnosis unit.

5. The image processing apparatus according to claim 1, wherein the diagnosis unit performs, when the user selects a menu indicating that fax reception is impossible at all from among the menus, at least one of a board failure diagnosis and a line cable connection diagnosis as the diagnosis.

6. The image processing apparatus according to claim 2, further comprising a fax board and a modem,
wherein at least one of a connection check and a communication check between the fax board and the modem, a check of the reading and writing of a value of a port-IC register, and a revision check is performed in the board failure diagnosis.

7. The image processing apparatus according to claim 6, wherein the modem connects to a telephone network via a line cable and an NCU, and
wherein a voltage value applied to the NCU side is checked two or more times, and when the voltage value checked is equal to or more than a threshold at least one time, it is determined that the line cable is correctly connected in the line cable connection diagnosis.

8. The image processing apparatus according to claim 7, wherein at least one of detection of a dial tone sent from the telephone network, detection of the dial tone when dialing with a circuit type stored in advance, and detection of the dial tone when dialing with all circuit types selectable in the image processing apparatus is performed in the circuit type diagnosis.

9. The image processing apparatus according to claim 1, wherein the diagnosis unit performs, when the user selects a menu indicating that transmission by any one of Email, SMB, FTP, I-FAX, and WebDav is impossible from among the menus, a network connection diagnosis as the diagnosis.

10. The image processing apparatus according to claim 9, wherein a network connection is determined to be correct in the network connection diagnosis when an IP address has been obtained in a case where an IP address setting method set in advance in the image processing apparatus is automatic, and
wherein the network connection is determined to be correct in the network connection diagnosis when the IP address has been set and a link-up state is established in a case where the IP address setting method is manual.

11. The image processing apparatus according to claim 1, wherein the first display unit displays the menus when a user uses any of the various functions and an error symptom occurs in the function being used.

12. The image processing apparatus according to claim 1, wherein the first display unit displays the menus when the image processing apparatus is activated.

13. A control method for an image processing performing various functions related to an image process according to a user operation, the control method comprising:
displaying menus indicating error symptoms of the various functions that may occur in the image processing apparatus so as to be selectable by a user;
performing, when the user selects one of the menus, a diagnosis of the image processing apparatus according to an error symptom indicated in the menu selected by the user; and
displaying a solution based on a diagnosis result by the diagnosis.

14. A non-transitory computer readable storage medium storing a program for causing a computer to execute a control method for an image processing apparatus performing various functions related to an image process according to a user operation, the control method comprising:
displaying menus indicating error symptoms of the various functions that may occur in the image processing apparatus so as to be selectable by a user;
performing, when the user selects one of the menus, a diagnosis of the image processing apparatus according to an error symptom indicated in the menu selected by the user; and
displaying a solution based on a diagnosis result by the diagnosis.
